(19) United States
(12) Patent Application Publication
(10) Pub. No.: US 2012/0229863 A1
(43) Pub. Date: Sep. 13, 2012

(54) IDLE COLOR SEPARATION ALGORITHM

(75) Inventors: Anthony J. Lima, Bristol, RI (US); Christopher M. Whittier, West Warwick, RI (US)

(73) Assignee: ASTRO-MED, INC., Warwick, RI (US)

(21) Appl. No.: 13/045,059

(22) Filed: Mar. 10, 2011

(51) Int. Cl. H04N 1/405

(52) U.S. Cl. 358/3.06

(57) ABSTRACT

An algorithm to control a printer wherein the separation set that is created for each print job is stored and managed in a storage unit within either the printer of the device that transmits the print job to the printer. The stored image separations are ranked or prioritized based on the frequency with which a particular job is printed. When the printer goes into an idle mode, such as between print jobs, the algorithm executes a re-separation or recalculates of each of the stored separation sets in descending order of the popularity of the separation set. The recalculation then accounts for changes or updates in the printing conditions thereby making it likely that the most popular separation set has been refreshed with current density compensation data.

### BACKGROUND OF THE INVENTION

The present invention relates generally to a new algorithm for reducing print job start time by managing storage of repetitive half-tone separation sets. More specifically, the present invention relates an algorithm for storing, managing and refreshing half-tone separation sets for repetitive print jobs during printer idle time in an manner that reduces or eliminates lag time for the start of a print job.

Generally in the prior art, printers create images using a combination of ink from a limited color palette by overlying the available colors in manner that creates the appearance of much broader range of colors. For example, most color printers have either three or four different colors available for printing wherein a three color printer includes three heads for printing cyan, yellow and magenta inks and a four color printer includes four heads for printing cyan, yellow, magenta and black. The printer then utilizes the available ink colors, in varying combinations to produce a broad range of composite colors.

In this context, it should be appreciated by one skilled in the art, that any particular ink supply, such as a transfer ribbon or ink tank, only has one ink available for use in a printing operation and is accordingly only capable of printing one shade of color no matter how much of the ink is transferred from the ink supply to the media. Therefore, in order to create various shades or intensities of any given color, the printer utilizes a form of visual deception known as half-toning. Still further, since a limited number of individual inks or toners are available to create the image, the true color image data must be separated into the individual color channels (CYAN, MAGENTA, YELLOW and BLACK) that are used in overlying relation with one another to represent the original image on a digital printing device.

The output generated by this half-toning process is stored in a set of image separations, with each individual separation within the set representing the required data for the proper reproduction of one color channel. These image separations are typically produced at the start of each print job and are calibrated based on various printing conditions that are evaluated at the time that the separations are created. However, generating image separations can be a time consuming process, as each individual pixel in an image needs to be broken down into its individual color channel components. This time is normally spent at the start of a print job, increasing the time before printing begins. As a result, every time a print job is sent to the printer, the separation sets must be calculated and saved prior to the start of the print job itself. Further, as printing conditions change sufficiently to require re-calibration, the image data needs to be re-separated to correct the separation set data in order to adjust for the change in print density.

There is therefore a need for a printer control algorithm that reduces print job start time by managing storage of repetitive half-tone separation sets. There is a further need for a printer control algorithm for storing, managing and refreshing half-tone separation sets for repetitive print jobs during printer idle time in an manner that reduces or eliminates lag time for the start of a print job. There is still a further need for a printer control algorithm that prioritizes, stores and refreshes half-tone separation sets for repetitive print jobs based on high probability during printer idle time in an manner that reduces or eliminates lag time for the start of a print job.

### BRIEF SUMMARY OF THE INVENTION

In this regard, the present invention provides a new algorithm for reducing print job start time by managing storage of repetitive half-tone separation sets. More specifically, the present invention provides an algorithm for storing, managing and refreshing half-tone separation sets for repetitive print jobs during printer idle time in an manner that reduces or eliminates lag time for the start of a print job.

In accordance with the present invention the separation set date that is created for each print job is stored and managed in a storage unit within either the printer or the device that transmits the print job to the printer. The stored image separations are ranked or prioritized based on the frequency with which a particular job is printed. When the printer goes into an idle mode, such as between print jobs, the algorithm executes a re-separation or recalculation of each of the stored separation sets in descending order of the popularity of the separation set. The recalculation then accounts for changes or updates in the printing conditions thereby making it likely that the most popular separation set has been refreshed with current density compensation data.

With the idle separation algorithm in place, the present invention reduces the number of times a user must wait for separations at print time. In the best case there is only a wait on separation time when new images are sent with a print job. In the worst case a user sends a job that requests separation sets after new density readings have been applied, but before the idle separation algorithm can re-separate them resulting in a wait that would simply be equal to the wait time experienced in the prior art when all separation data must be freshly calculated for each print job sent.

It is therefore an object of the present invention to provide a printer control algorithm that reduces print job start time by managing storage of repetitive half-tone separation sets. It is a further object of the present invention to provide a printer control algorithm for storing, managing and refreshing half-tone separation sets for repetitive print jobs during printer idle time in an manner that reduces or eliminates lag time for the start of a print job. It is still a further object of the present invention to provide a printer control algorithm that prioritizes, stores and refreshes half-tone separation sets for repetitive print jobs based on high probability during printer idle time in a manner that reduces or eliminates lag time for the start of a print job.

These together with other objects of the invention, along with various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there is illustrated a preferred embodiment of the invention.

### BRIEF DESCRIPTION OF THE DRAWINGS

In the drawings which illustrate the best mode presently contemplated for carrying out the present invention:

FIG. 1 is a schematic illustration of a system on which the control method of the present invention operates; and

FIG. 2 is a flow chart depicting the control method of the present invention.

### DETAILED DESCRIPTION OF THE INVENTION

As was stated above, the present invention is generally directed to a new algorithm for reducing print job start time by actively managing storage of repetitive half-tone separation sets. More specifically, the present invention is directed to an algorithm for storing, managing and refreshing half-tone separation sets for repetitive print jobs during printer idle times in a manner that reduces or eliminates lag time for the start of a print job.

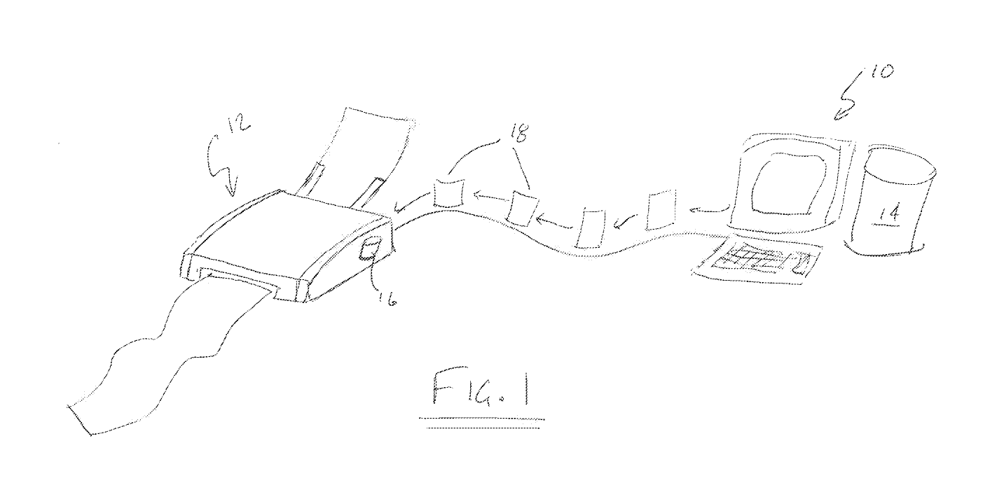

In accordance with the present invention, as depicted at FIG. 1, a control algorithm is provided for operation on a system that employs a computing device 10 that is interconnected with a printer 12 either through a direct wired connection, a network connection or a wireless connection. The computing device 10 includes a processer and memory 14 therein. Further, the printer 12 also preferably includes storage memory 16 therein. In order to execute a print job, separation set data 18 is created for each print job. While in the prior art the separation set data 18 is discarded after each job, the separation set data 18 of the present invention is stored and managed in a storage unit within either the printer 12 or the computing device 10 that transmits the print job to the printer 12. The stored image separations 18 are ranked or prioritized based on the frequency with which a particular job is printed. When the printer goes into an idle mode, such as between print jobs, the algorithm executes a re-separation or recalculates each of the stored separation sets in descending order of the popularity of the separation set. The recalculation then accounts for changes or updates in the printing conditions, thereby making it likely that the most popular separation set has been refreshed with current density compensation data.

In general, the algorithm of the present invention is equally applicable to any type printing operation and may be applied with equal efficacy to monochromatic (black and white), grayscale or color printing operations. Further the algorithm of the present invention may be incorporated into the control system for any type of printer that relies on a half toning process for generating printed output. Such printers may include, but are not limited to, thermal transfer printers, direct thermal printers, dye sublimation printers and laser printers for example. In addition, the algorithm of the present invention may be implemented on a computer device, which then transfers the processed image to a printer for generating the output based on commands sent from the computer.

As is well known in the art, consistent electrostatic printing is highly dependent upon environmental conditions and the condition of the photoconductive surfaces that are used in the printing process. As a result, these printers require regular print density calibration to account for the varying printing conditions. One step in the calibration process determines correction factors used to alter the image data to be printed. In the prior art, these correction factors were incorporated into the image data halftone process at the time that the halftone data is created. The output created during the half toning process can be referred to as a set of image separations, with each separation representing data for one color channel. As printing conditions change sufficiently to require re-calibration, image data needs to be re-separated to recalibrate the correction factors in order to adjust the output print density.

As was stated above, however, generating image separations can be a time consuming process as each individual pixel in an image needs to be broken down into its individual color channel components. In the prior art, this time is normally spent at the start of each and every print job, increasing the time before printing begins. To overcome this start time lag, the present invention provides for the storage of often printed image data and the maintaining of a set of separations based upon the latest calibration factors that are periodically refreshed during inactive periods, therefore reducing or eliminating the time at the start of printing.

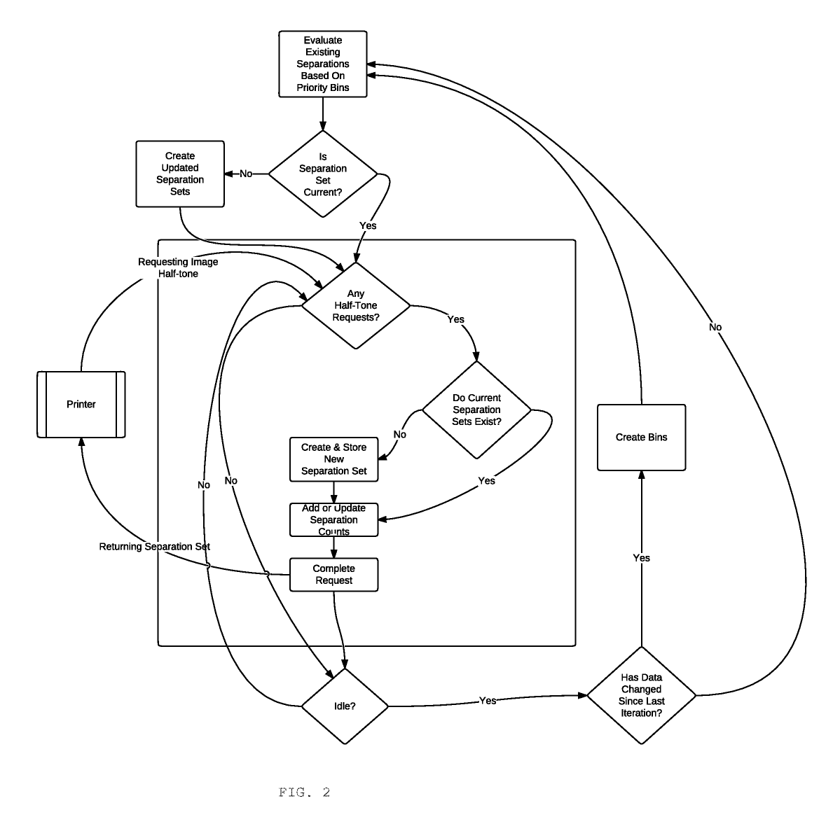

As depicted in the flow chart at FIG. 2, in operation, the algorithm of the present invention, as will be detailed below, manages and stores separation sets that are created based on the original image, the halftone options associated with it and the black tolerance threshold. These options are saved to a data file as parameters listed under a section defined by the separation name. If an image to be printed is being separated for the first time, a “Total Count” parameter is incremented in the data file that keeps track of how many separations sets exist in total. A “Count” parameter that is also attached to each separation set keeps track of how many times that particular separation set has been requested. Since a user can potentially have an extremely large number of separation sets stored the “Count” parameter serves as a measure of the popularity of any given separation set within the totality of the stored separation sets. Further, a “Maxcount” parameter is employed to track the highest number of requests for any single separation set.

In order to the chance that the user tries to use a separation set that exists but has not yet been updated to acceptable density compensation, the algorithm attempts to predict which separation sets will be used and re-separate those first. The algorithm uses the “Count” parameter to track of how many times the system has requested each separation set in order to give re-separation priority by popularity. Each time the printer device enters the idle function or when a restart flag is set all of the stored separation sets are broken into popularity categories. While the number of categories is not critical, the preferred embodiment employs 5 categories. Accordingly, for the remainder of the example we will employ 5 catergories, although one skilled in the art will understand that any other number of categories would work equally well. The categories are created by dividing the total number of separation sets, based on their “count” parameter, into 5 even ranges or “bins” from 1 (set has only requested once) to the “maxcount” parameter (the most number of requests for a single set). For example, if “maxcount” was 500, then the 5 bins are defined with “count” ranges from 500-401, 400-301, 300-201, 200-101 and 100-1. Once the bins are defined, a list of all stored separation data files is polled and held in memory. Starting with the highest popularity bin, each time the printer enters idle mode, the algorithm checks the “count” parameter of each separation data file to determine if it is in the bin that is currently being looked for. If the separation data file “count” parameter does not place it in the current bin the algorithm moves to the next file within the list. If the separation data file “count” parameter does fall into the current bin, the algorithm calls another function, a “HalftoneRequest” function defined elsewhere, that checks the data file to determine if the separation is acceptable. If the separation data is no longer acceptable, new separation data is created. If the separation data is acceptable the separation data file is left alone. In either case the algorithm again moves on to the next separation data set. When the function exits, the current state is saved statically and is maintained as a starting point for the next idle function call. Once the end of the file list is reached the algorithm moves to the next bin and restarts its traversal of the separation data file section list. After completing re-separation queries for all 5 bins, a restart flag is set to allow the entire process to begin all over again.

It should be noted that system idle is defined as anytime that the printer is not receiving new label information from a host computer (new label formats, download of label images or fonts), is not printing or is not performing internal maintenance. So, for example, if the printer has just completed printing a job it will resume idle separations immediately. If a new job comes in, or if the user initiates an operation from the printer's menus, idle separation is aborted and resumes when the higher priority operation is complete.

With the idle separation algorithm of the present invention in place, a reduction has been achieved in the number of times required to wait for separations at print time. In the best case application of the algorithm there is only a wait on the time required to generate separations when new images are sent with a print job. In the worst case, a user sends a job that requests separation sets after new density readings have been applied and before the idle separation algorithm has had an opportunity to re-separate them if they have fallen out of an acceptable range thereby requiring a wait time for the regeneration of separation sets.

It can therefore be seen that the present invention provides a novel printer control algorithm that reduces print job start time by managing storage of repetitive half-tone separation sets. Further it can be seen that the present invention provides a printer control algorithm for storing, managing and refreshing half-tone separation sets for repetitive print jobs during printer idle time that refreshes half-tone separation sets for repetitive print jobs based on high probability during printer idle time in an manner that reduces or eliminates lag time for the start of a print job. For these reasons, the present invention is believed to represent a significant advancement in the art, which has substantial commercial merit.

While there is shown and described herein certain specific structure embodying the invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed:

1. A method for saving and managing halftone separation sets created and transmitted to a printer for use in print jobs, comprising:
creating a plurality of halftone separation sets containing environmental condition adjustments;
storing said halftone separation sets at a memory location;
assigning a numerical value to each halftone separation set based on the frequency at which said printer calls for said halftone separation set;
reviewing the printing condition adjustments associated with each of said halftone sets in declining order of the frequency at which said printer calls for said halftone separation set when said printer enters an idle mode; and
replacing halftone sets that include environmental condition adjustments that are obsolete.

2. The method of claim 1, further comprising:
tracking said numerical values assigned to each halftone separation set to determine which halftone separation set has the largest numerical value associated therewith.

3. The method of claim 2, wherein said method further comprises:
creates at least two equal bin ranges based on the range of said numerical values extending from 1 to the largest numerical value assigned to each halftone separation.

4. The method of claim 3, wherein said step of reviewing the printing condition adjustments associated with each of said halftone sets in declining order of the frequency at which said printer calls for said halftone separation set when said printer enters an idle mode further comprises:
reviewing the printing condition adjustments associated with each of said halftone sets in declining order of the bin range into which the frequency at which said printer calls falls for said halftone separation set when said printer enters an idle mode.

5. The method of claim 1, wherein said method is performed by a controller in a printing device.

6. The method of claim 1, wherein said method is performed on a computer processor.

7. A system for saving and managing halftone separation sets created and transmitted to a printer for use in print jobs, comprising:
a device for creating a plurality of halftone separation sets containing printing condition adjustments;
a storage device for storing said halftone separation sets at a memory location within said storage device; and
an algorithm operable on said device or said storage device for managing said halftone separation sets, said algorithm assigning a numerical value to each halftone separation set based on the frequency at which said printer calls for said halftone separation set, reviewing the printing condition adjustments associated with each of said halftone sets in declining order of the frequency at which said printer calls for said halftone separation set when said printer enters an idle mode, and replacing halftone sets that include printing condition adjustments that are obsolete.

8. The system of claim 7, wherein said algorithm tracks said numerical values assigned to each halftone separation set to determine which halftone separation set has the largest numerical value associated therewith.

9. The system of claim 8, wherein said algorithm further creates at least two equal bin ranges based on the range of said numerical values extending from 1 to the largest numerical value assigned to each halftone separation.

10. The system of claim 9, wherein said algorithm reviewing the printing condition adjustments associated with each of said halftone sets in declining order of the frequency at which said printer calls for said halftone separation set when said printer enters an idle mode further comprises:
said algorithm reviewing the printing condition adjustments associated with each of said halftone sets in declining order of the bin range into which the frequency at which said printer calls falls for said halftone separation set when said printer enters an idle mode.

11. The system of claim 7, wherein said algorithm is performed by a controller in a printing device.

12. The system of claim 7, wherein said algorithm is performed on a computer processor.
